(19) United States
(12) Patent Application Publication
(10) Pub. No.: US 2005/0283368 A1
(43) Pub. Date: Dec. 22, 2005

(54) System and method for automated personalized alerts using interactive voice response

(76) Inventor: Kam Lung Leung, Aurora, CO (US)

Correspondence Address: KAM LUNG LEUNG, 22681 EAST RIDGE TRAIL DRIVE, AURORA, CO, 80016, US

(21) Appl. No.: 11/156,097

(22) Filed: Jun. 17, 2005

Related U.S. Application Data
(60) Provisional application No. 60/557,961, filed on Jun. 22, 2004.

(51) Int. Cl. G10L 21/00

(52) U.S. Cl. 704/270

(57) ABSTRACT

A communication is received from a user. A receiving device recognizes a user's voice request through the use of interactive voice response technologies. The user chooses system options, personal options, and/or delivery options. A personalized alert message is recorded by the user and appropriate actions are then taken to store and deliver the alert according to the delivery options set by the user. The system can be used to deliver one or more alerts to one or more parties at one or more date/time combinations.

### CROSS-REFERENCE TO RELATED APPLICATIONS

This application claims benefit of U.S. Provisional Application No. 60/557,961, entitled “System And Methods For Interactive Voice Response Alerts Scheduling And Alerts Reminding” and filed on Jun. 22, 2004, which is specifically incorporated herein by reference for all that it discloses and teaches.

### TECHNICAL FIELD

The invention relates generally to communications, computer software and computer systems, and more particularly to a system and method for automated personalized alerts using interactive voice response.

### BACKGROUND

The communications marketplace of today is being driven by a number of key technologies. One of the most important of those technologies is mobile telephones, cellular or otherwise. People carry such phones with them wherever they go. They can make and receive calls while watching a soccer game, buying groceries, driving to work, etc. In fact, one of the reasons behind the unbelievable penetration of mobile phone technology has been the need to place and receive calls while on the go—free time is a dwindling resource and being able to communicate without being “plugged into the wall” saves people time.

Mobile phone designers and manufacturers have apparently recognized the value of time-management and time-saving features, as today's phones increasingly contain features such as calendars, to do lists, alarms, reminders, etc. While useful, many of these alert features are difficult to activate, as a series of menus must be manually navigated using a small keypad. Furthermore, different phones have different features and menu structures and often do not communicate well with each other. For example, sending a reminder that has been entered on one phone to the phone of a business colleague can be difficult, if not technically impossible. Alternatively, a call can be placed to the colleague and a message left for her on a voicemail system. However, for the colleague to receive the message she must dial in and retrieve her voicemail (and she must know that she needs to retrieve her messages).

Alternative systems exist for dialing one or more numbers and delivering messages. Some of these systems deliver a predetermined broadcast message while other systems allow the message to be customized for each recipient. For example, some airlines use systems that can call travelers who have departure flights on a given day. The systems update each traveler with their flight times and can even report flight delays or other changes. Although somewhat customizable by the traveler, these systems do not allow him or her to completely control the reminder and alert experience, nor do they allow for the traveler to use the systems in non-travel-related ways. More importantly, the traveler can not submit a fully personalized message for delivery.

Although another group of services has developed that attempts to address the need for automated telephonic alerts, it has not been entirely successful. Wake-up services allow users to call in and setup automated reminders. The system calls the user at a user-specified time and delivers a standard wake-up message. However, such systems are limited in that they offer little in the way of customizing or personalizing messages, submitting call lists, utilizing caller-ID enabled features, etc. Furthermore, a critical feature of an alert reminder service is on-time delivery of alerts; necessitating multi-layered redundancy, fault tolerance and scalability—features that are often lacking in current systems.

### SUMMARY

Implementations described and claimed herein address the foregoing problems by providing a system and method for creating and delivering, in an automated fashion, personalized reminders and alerts using voice messaging. The messages can be delivered to any voice-based communications device including a mobile phone, office phone, home phone, etc. When a user calls into the system, the system recognizes a user's voice request through the use of voice-recognition technologies or by manual entry of associated menu numbers. A personalized message can be recorded and the system then takes appropriate actions to deliver the message. For example, in one implementation, a user requests that the system send an immediate message to his “Alpha Team”. The user then records the message: “Today's 4 pm meeting has been cancelled.” The system stores the message, processes the request, accesses the necessary pre-entered data concerning the user and his “Alpha Team”, and delivers a personalized message to the team members.

In one implementation, a system provides automated personalized alerts using interactive voice response technologies. The system receives an initiating communication from a user, interprets the communication into digital data, accesses account information for the user, and communicates with the user to receive an alert. The alert has at least one triggering time and date as well as at least one action associated with it. The system stores the alert and monitors the storage location. When a triggering date and time arrives, the system recognizes that the alert must be acted upon and sends the alert to an outgoing communications module or operation. The module can be implemented in any number of ways including, but not limited to, as a method of performing steps or actions, a computer software program, or a computer process. The module can also be computer hardware, or a combination of hardware and software such as a computer server running software. The system interprets the active alert and performs the associated action. For example, the system could call a number and deliver a personalized voice message. In another implementation, the system is implemented as a computer program product encoding a computer program for a computer process that executes on a computer system.

In another implementation, the system is composed of modules or operations that complete tasks. For example, the system has a module that provides a means for completing an operation that receives an initiating communication from a user, another that has a means for interpreting the communication into digital data, and yet another that provides a means for accessing account information for the user based on the digital data. Furthermore, the system has an operation that provides a means for communicating with the user to receive an alert having at least one triggering date and time and at least one associated action that is to be taken when a triggering date and time occur. Other system modules include one that provides a means for creating a storage entry for the alert in a storage location and another that provides a means of monitoring the storage location in order to match a triggering date and time on the alert with a selected date and time, for example, the current date and time. In addition, the system has a module that provides a means for sending the matched alert to an outgoing communications module. The outgoing communications module provides a means of interpreting the alert and performing whatever action is associated therewith.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program.

Other implementations are also described and recited herein.

### BRIEF DESCRIPTION OF THE DRAWINGS

FIG. 1 illustrates an exemplary environment for providing automated personalized alerts.

FIG. 2 illustrates an exemplary system for providing automated personalized alerts.

FIG. 3 illustrates an exemplary system for receiving an inbound communication.

FIG. 4 illustrates an exemplary system for performing an outbound alert delivery.

FIG. 5 illustrates an exemplary computing system useful in implementations of the described technology.

### DETAILED DESCRIPTIONS

In the busy, highly-mobile world of today there is a need for automated alerts and assistance in remembering tasks, appointments, events, etc. The implementations described and claimed herein address the need by providing a system and method for creating and delivering, in an automated fashion, reminders and alerts using voice messaging. As mobile phones are often with their owners, delivery of alerts to mobile phones is one implementation. However, different people use different technologies, and in another implementation, the receiving device can be any voice-based communications device including an office phone, a home phone, a computer with voice-over-internet-protocol technologies, etc.

In one implementation, a user initiates contact with the system via a communications device. The system uses caller-identification technologies to automatically recognize the user's phone number and identifies the corresponding user from a compilation of user information. In another implementation, a user utilizes a computer to contact the system and use its features. Regardless of the method for connecting the user and the system, an authorization code can be requested by the system before access is granted. In another implementation, no authorization code is required. If the caller-identification technologies are unable to recognize the calling communications device, the system prompts the caller to enter identifying information.

Once the system has granted access to the user, it listens and responds to the user's voice requests through the use of interactive voice response technologies. Alternatively, the system can accept manual entry of requests. A personalized message can be recorded by the user and the system then takes appropriate actions to deliver the message. For example, in one implementation, a user requests that the system send a message to her home phone on Jan. 15, 2006 at 7:00 am. The user then records the message: “the annual report needs to be sent to Bob Smith.” The system processes the request, accesses the necessary pre-entered data concerning the user, and stores the message for later delivery. When the appropriate date and time arrive (i.e., 7:00 am, Jan. 15, 2006) the system retrieves the user's request, associated data, and voice message and then calls the user and delivers the message.

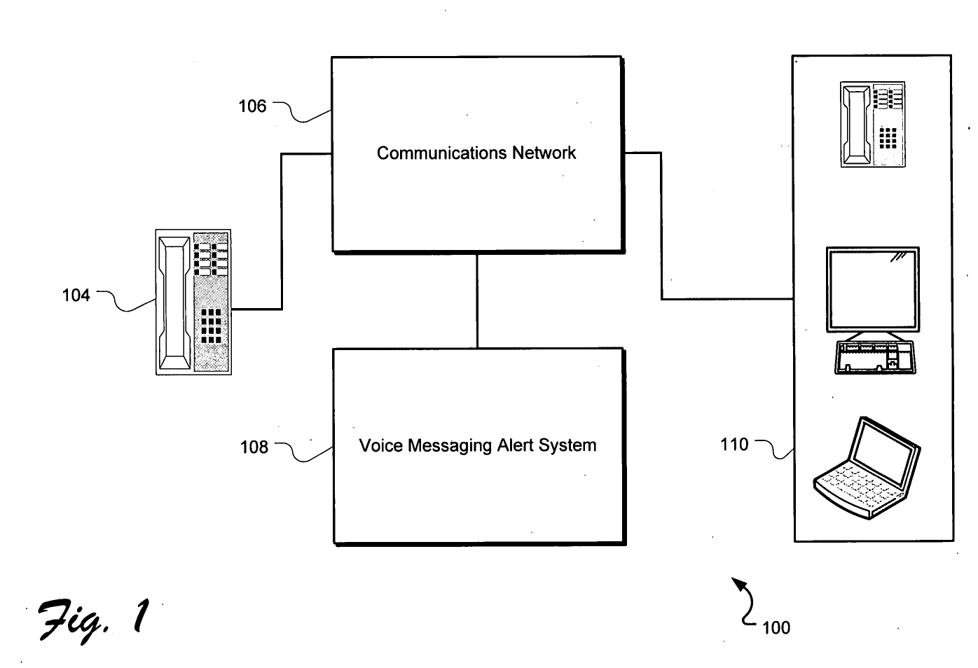

FIG. 1 illustrates an exemplary environment for providing automated personalized alerts 100 including an initiating communications device 104, a communications network 106, a voice messaging alert system 108, and receiving communications devices 110. The user of the voice messaging alert system 108 utilizes the initiating communications device 104 to communicate with the voice messaging alert system 108. The initiating communications device 104 can be any type of communications device including, but not limited to, a mobile phone, office phone, pay phone, computer using voice-over-internet-protocol (VOIP), home phone, email device, etc. If the initiating communications device 104 can be uniquely identified via caller identification (caller-ID) technologies, the voice messaging alert system 108 can associate the initiating communications device 104 with an existing user. In such a case, the voice messaging alert system 108 accesses user-specific information and prepares to interact with the user. The user communicates with the voice messaging alert system 108 and leaves an alert for delivery at a specified date and time. The voice messaging system 108 waits until the appropriate delivery date and time and then delivers the alert to the receiving communications devices 110. In an alternate implementation, the user specifies only a delivery date or time, not both. In another implementation, the user specifies multiple dates and/or times. In yet another implementation, the user schedules the alert according to some interval of time. It should be appreciated that the exemplary environment for providing automated personalized alerts 100 illustrated in FIG. 1 is just one of many possible implementations and has been simplified to provide an overview explanation.

The receiving communications devices 110 are one or more communications devices. The receiving communications devices 110 can be any type of communications devices including, but not limited to, mobile phones, office phones, pay phones, computers using voice-over-internet-protocol (VOIP), home phones, email devices, etc. In an alternate implementation, the receiving communications devices 110 are one or more groups of communications devices. The user defines caller groups before placing the initiating call or defines them concurrently with the initiating call. Caller groups can be family members, work colleagues, friends, team members, etc. For example, a coach of a basketball team is the user. She wants to define a caller group composed of the name and telephone number of each member of her team. In one implementation, the coach uses a telephone as the initiating communications device 104 to contact the voice messaging alert system 108. The voice messaging alert system 108 responds to the coach's voice command “setup caller group” with voice prompts asking her to speak the name and number of each team member. In another implementation, the coach uses a computer as the initiating communications device 104. She accesses the voice messaging alert system 108 via an Internet link, e.g., a website, and enters her team's information. In yet another implementation, the coach sends an email to the voice messaging alert system 108 in order to set up the caller group. The voice messaging alert system 108 stores the caller group for future use.

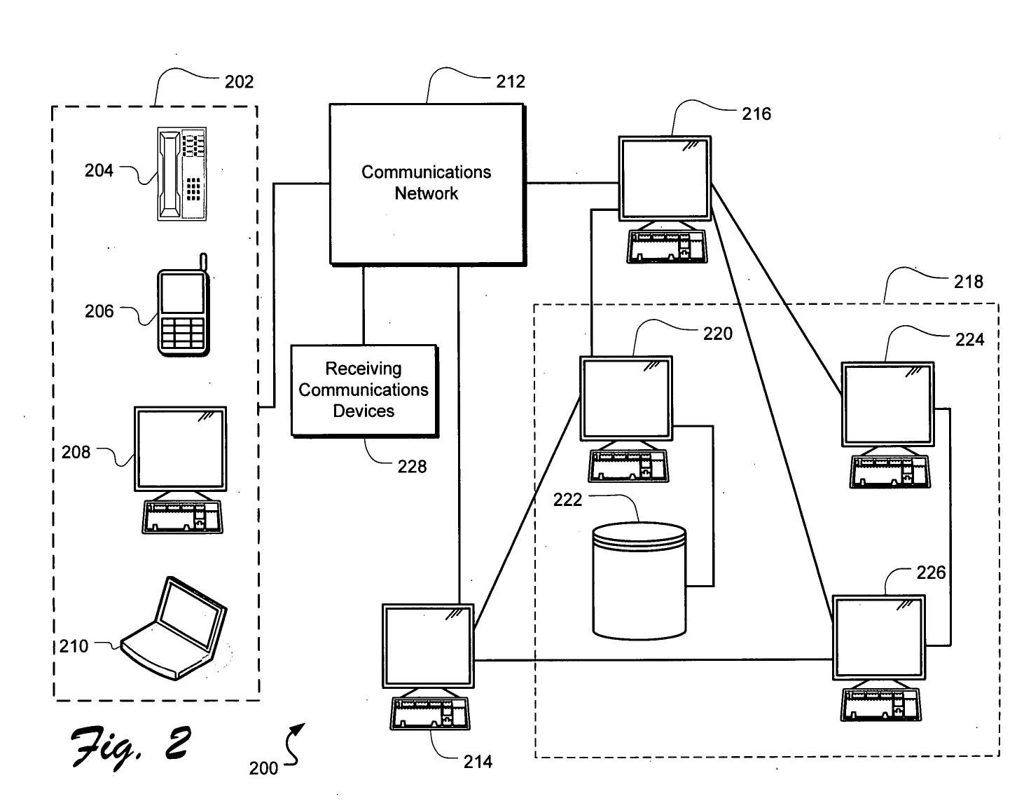

FIG. 2 illustrates an exemplary system for providing automated personalized alerts 200. The components include initiating communications devices 202 such as an office telephone 204, mobile telephone 206, workstation using VOIP 208, or laptop using VOIP 210; communications network 212; inbound voice server 214; outbound voice server 216; processing devices 218; alert application server 220; database server 222; alert messaging server 224; and an alert information storage server 226.

It is important to note that in addition to the initiating communications devices 202 shown in FIG. 2, others may be used including, but not limited to, a home phone, pay phone, computer or other device capable of sending an email, etc. The initiating communications devices 202 are connected via a communications network 212. The communications network 212 can be the public switched telephone network (PSTN), a VOIP network, the Internet, a private switched telephone network, etc. The PSTN is another name for the public telephone system—home phones, business phones, mobile phones, pay phones, etc. are connected to each other by the PSTN.

The inbound voice server 214 can be a computer system or software product that interprets incoming information and converts it into data that can be understood by software that can operate on the inbound voice server 214. An incoming communication arrives at the inbound voice server 214 as digital data, or as an analog signal, from the communications network 212. In one implementation, the inbound voice server 214 processes the digital data and takes appropriate actions. In another implementation, the inbound voice server 214 interprets the analog signal, generates digital data, and takes appropriate actions. The inbound voice server 214 communicates with the processing devices 218 to fulfill the operations requested by a user via an inbound communication.

The outbound voice server 216 can be a computer system or software product that receives communications from the processing devices 218, interprets the communications, and converts the communications into operations such as outgoing calls and voice messages. The outbound voice server 216 initiates the operations by placing the appropriate outgoing calls and delivering the appropriate messages. The outgoing voice server 216 may perform other actions, such as, sending a voice message as a digital file, sending an alert as an attachment to an email, etc.

The processing devices 218 include an alert application server 220, a database server 222, an alert messaging server 224, and an alert information storage server 226. The alert application server 220 builds the VoiceXML pages or other sets of instructions that are used to interact with the user. The database server 222 stores user-specific information as well as other data that is used by the system. The alert messaging server 224 aggregates the outgoing communications operations and communicates them to the outbound voice server 216. The alert information storage server 226 stores the alerts and associated messages until the appropriate date and time for each alert are reached and then communicates them to the alert messaging server 224. In an alternate implementation, the alert has only a delivery date or time, not both. In another implementation, the alert has multiple delivery dates and/or times. In yet another implementation, the alert is scheduled for multiple deliveries according to some interval of time.

It is important to realize that each of the servers described above can be implemented as an operation, as groups of operations or processes, as computer hardware, or as individual computer systems like those depicted in FIG. 2. In an alternate implementation, two or more of the servers can be implemented onto a single computer system, for example, as software products running concurrently on the computer system. In yet another implementation, individual server functionalities can be spread out across multiple computer systems either by having different computer systems perform different functions of the overall server functionalities or by having each computer system perform the complete set of server functionalities while dividing the workload among the computer systems. These features make the system highly scalable and highly fault tolerant. Thus, the system can easily and quickly grow in size and capacity as needed. In one implementation, the system includes multiple computing systems for each server described in FIG. 2, thereby making the system fault tolerant; one or more computers that make up the system can experience a fault or otherwise fail without causing the system to stop functioning.

The inbound voice server 214 requests VoiceXML pages or other sets of instructions from the alert application server 220. The alert application server 220 builds the VoiceXML pages or other sets of instructions by combining the requests from the inbound voice server 214, system information such as what options are available, and user-specific account information retrieved from the database server 222. In an alternate implementation, the user-specific account information is retrieved from the alert application server 220 or some other location and no database server is used.

In one exemplary implementation, the inbound voice server 214 receives an initiating communication from a user. The initiating communication can be a phone call, an email, or some other form of communication. The inbound voice server 214 interprets the communication into digital data and then sends the caller-ID number, or other user-identifying information (perhaps entered be the user), and other communication information to the alert application server 220. The alert application server 220 communicates with the database server 222 in order to retrieve the user-specific account information based on the user-identifying information. The alert application server 220 then combines the user-specific information with system information such as voice messaging options for this particular user, constructs a VoiceXML page or other set of instructions, and sends the resulting information back to the inbound voice server 214. The inbound voice server 214 interprets the information, follows the instructions therein, and communicates the alert options to the user. The inbound voice server 214 employs interactive voice response to communicate with the user. The inbound voice server 214 receives a personalized alert from the user. The user creates the alert by choosing appropriate options during the communication with the inbound voice server 214. In an alternate implementation, the initiating communication included the alert and any options such that no additional interaction with the user is necessary.

An alert has a date and time associated with it. In an alternate implementation, the alert has only a delivery date or time, not both. In another implementation, the alert has multiple delivery dates and/or times. In yet another implementation, the alert is scheduled for multiple deliveries according to some interval of time. The alert also contains whatever action the user would like the system to perform when a particular date and time occurs. For example, one action is to call a phone number specified by the user and deliver the personalized message left by the user. Another example of a possible action is to call ten numbers associated with a group name and deliver a previously stored message such as “no team practice today.” It should be noted that it is possible for the system to accommodate many other action requests and the previous examples are not to be interpreted as limiting in any way.

Both the inbound voice server 214 and the outbound voice server 216 communicate with the alert information storage server 226. The alert information storage server 226 stores alerts, such as voice messages and related data, from inbound communications as communicated to the alert information storage server 226 from the inbound voice server 214. In one implementation, the alert information storage server 226 creates a directory and any necessary parent directories for each alert using a computer system's file structure. The alert information storage server 226 creates a file in the directory and stores the alert in the file. For example, if an alert is received that specifies message delivery on 8/16/2006 at 9:15 am, the alert information storage server 226 looks for a “2006” directory and creates one if it does not exist. Under the “2006” directory, the alert information storage server 226 looks for a “08” directory, once again creating it if it does not exit. The process continues until the following directory structure exists: “\2006\08\16\9\15\”. The alert information storage server 226 then writes a file inside the “15” directory containing the alert information. If a voice message or other communication is associated with the alert, it is stored as a file in directory “15” as well. In another implementation, the alert information storage server 226 uses a database to store alert information. In yet another implementation, the alter information storage server 226 stores alert information as entries in a file or group of files. It should be noted that there are many methods for storing information that can be employed by the alert information storage server 226 without departing from the scope of the invention as embodied in the claims hereafter appended.

When a triggering date and time for an alert occurs, the alert information storage server 226 communicates with the alert messaging server 224 and sends the information concerning the particular alert to the alert messaging server 224. The alert messaging server 224 aggregates all incoming information and schedules actions such as outgoing calls and delivery of messages. When a triggering time and date is reached for a particular alert, the alert messaging server 224 notifies the outbound voice server 216 and instructs it to take the action specified in the alert. If the alert specifies delivery of a personalized communication, the outbound voice server 216 sends a request to retrieve the personalized communication to the alert information storage server 226. The requested communication is delivered by the alert information storage server 226 to the outbound voice server 216.

In another implementation, the alert messaging server 224 aggregates the alert operations sent to it by the alert information storage server 226, creates a schedule, and manages an outbound alerts queue. When a particular alert needs to be acted upon, the alert messaging server 224 communicates the alert information to the outbound voice server 216.

The outbound voice server 216 sends a request to the alert application server 220 instructing it to build a VoiceXML page or other set of instructions from information received by the outbound voice server 216 from the alert messaging server 224. The alert application server 220 sends the constructed VoiceXML page or other set of instructions to the outbound voice server 216. Depending on the type of alert, the outbound voice server 216 may request an associated personalized communication from the alert information storage server 226. The alert information storage server 226 sends the personalized communication to the outbound voice server 216. The outbound voice server 216 initiates an outbound communication to the recipient(s) of the alert as instructed in the VoiceXML page or other set of instructions that was created and delivers the personalized communication through the communications network 212 to the appropriate receiving communications device 228. Alternatively, as another example, the alert could specify a different action, such as calling a group of numbers and delivering a standard pre-recorded message. For example, the alert could specify that 8 people are to be called and the pre-recorded message “meeting starts in five minutes” could be played. In this case, the outbound voice server 216 would initiate an outbound communication with multiple receiving communications devices 228.

The receiving communications devices 228 are one or more communications devices. The-receiving communications devices 228 can be any type of communications devices including, but not limited to, mobile phones, office phones, pay phones, computers using voice-over-internet-protocol (VOIP), home phones, email devices, etc. In an alternate implementation, the receiving communications devices 228 are one or more groups of communications devices.

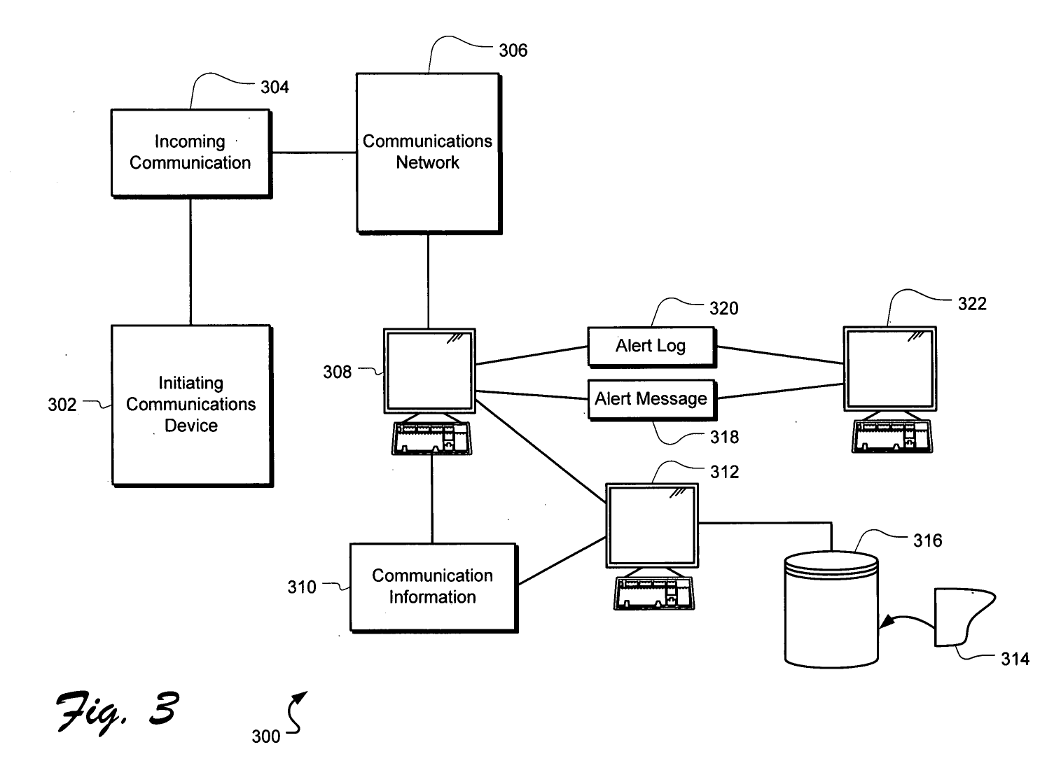

FIG. 3 illustrates an exemplary system for receiving an inbound communication 300. An initiating communications device 302 is used to create an incoming communication 304 that arrives via a communications network 306 and is routed to an inbound voice server 308. The initiating communications device 302 can be any type of communications device including, but not limited to, a mobile phone, an office phone, a pay phone, a voice-over-internet-protocol (VOIP) phone, a computer system implementing VOIP technologies, a home phone, an email device, etc. The incoming communication 306 is received by the inbound voice server 308. The inbound voice server 308 can be a computer system that interprets incoming information and converts it into data that can be understood by software that operates on the inbound voice server 308. In another implementation, the inbound voice server 308 is a set of operations that performs the same tasks. The inbound voice server 308 interprets the incoming communication 306 and converts it into communication information 310 that is then sent on to the alert application server 312.

If the initiating communications device 302 was uniquely identified by the inbound voice server 308 (for example, via caller-ID technology), then the incoming communication information 310 contains a caller-ID tag. In such a case, the communication information 310 sent to the alert application server 312 from the inbound voice server 308 allows the alert application server 312 to access specific information for the user from a data repository 314. In one implementation, the data repository resides on the alert application server 312. In another implementation, the data repository resides on a database server 316. In yet another implementation, the data repository resides in some other location and/or form. The alert application server 312 communicates with the database server 316 in order to retrieve user-specific information based on the caller-ID tag. Alternatively, if the inbound voice server 308 was unable to uniquely identify the initiating communications device 302, then the user must enter identifying information so that the alert application server 312 can retrieve the user-specific information based on the user-entered identifying information.

The alert application server 312 combines the user-specific information with system information such as voice messaging options for the user, creates a VoiceXML page or other set of instructions, and sends the resulting communication information back to the inbound voice server 308. In one implementation, the inbound voice server 308 interprets the information and prepares to interact with the user. The user communicates with the inbound voice server 308 and leaves an alert message 318 for delivery at a set time and date. In an alternate implementation, the user specifies only a delivery date or time, not both. In another implementation, the user specifies multiple dates and/or times. In yet another implementation, the user schedules the alert according to some interval of time. The inbound voice server 308 uses the communication information received from the alert application server 312 as well as information from the user to create an alert log 320. In another implementation, the initiating communication included information needed by the inbound voice server 308 to construct the alert log 320 as well as the alert message 318, such that no additional interaction with the user is necessary.

The inbound voice server 308 delivers the alert log 320 to the alert information storage server 322. The inbound voice server 308 also sends the alert message 318, if any, to the alert information storage server 322. The alert information storage server 322 stores the alert log 320 and any associated alert message 318. In one implementation, the alert information storage server 322 creates a directory and any necessary parent directories for the alert log 320 using a computer system's file structure. The alert information storage server 322 creates a file in the directory and stores the alert log 320 in the file. For example, if an alert log 320 is received that specifies delivery of an associated alert message 318 on December 11^{th} of 2006 (i.e., 12/11/2006) at 7:45 pm, the alert information storage server 322 looks for a “2006” directory and creates one if it does not exist. Under the “2006” directory, the alert information storage server 322 looks for a “12” directory, once again creating it if it does not exit. The process continues until the following directory structure exists: “\2006\12\11\19\45\” (note that times in the pm are converted to a 24 hour clock time, e.g. 7:00 pm becomes 1900 hours). The alert information storage server 322 then writes a file inside the “45” directory containing the alert log 320. If an alert message 318 is associated with the alert log 320, it is stored as a file in directory “15” as well. In another implementation, the alert information storage server 322 uses a database to store alert information. In yet another implementation, the alter information storage server 322 stores alert information as entries in a file or group of files. It should be noted that there are many methods for storing information that can be employed by the alert information storage server 322 without departing from the scope of the invention as embodied in the claims hereafter appended.

In an alternate implementation, the inbound voice server 308 receives a text message from an initiating communications device 302 that transmits via an HTTP protocol. The inbound voice server 308 has a web application running on it that processes the text message, e.g., performs a virus check, verifies structure, confirms lack of illegal characters, etc. Alternately, the web application can reside on another server. In one implementation, the text message contains a user identifier, a subscription identifier, a password, an email address or phone number, an alert time and date, and a text message. The inbound voice server 308 processes and converts the information into communications information 310 and sends it to the alert application server 312. The communications information 310 is then handled as above. In yet another implementation, the text message is an email and is delivered to the alert information storage server 322 for processing.

It is important to realize that each of the servers described above can be implemented as an operation, as groups of operations or processes, as computer hardware, or as individual computer systems like those depicted in FIG. 3. In an alternate implementation, two or more of the servers can be implemented onto a single computer system, for example, as software products running concurrently on the computer system. In yet another implementation, individual server functionalities can be spread out across multiple computer systems either by having different computer systems perform different functions of the overall server functionalities or by having each computer system perform the complete set of server functionalities while dividing the workload among the computer systems. These features make the system highly scalable and highly fault tolerant. Thus, the system can easily and quickly grow in size and capacity as needed. In one implementation, the system includes multiple computing systems for each server described in FIG. 3, thereby making the system fault tolerant; one or more computers that make up the system can experience a fault or otherwise fail without causing the system to stop functioning.

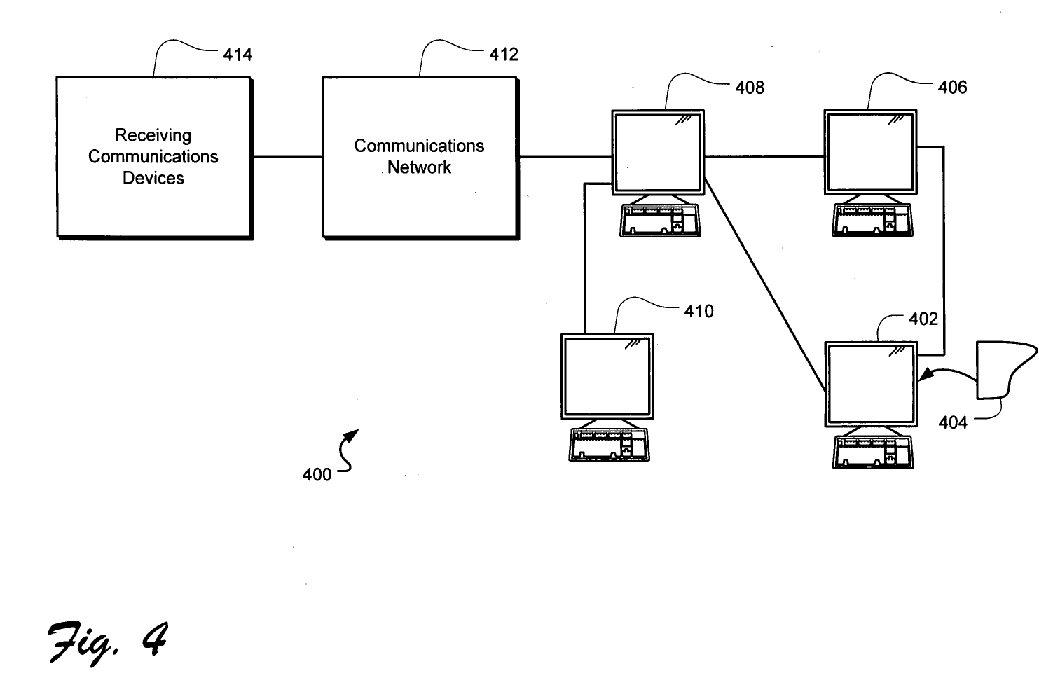

FIG. 4 illustrates an exemplary system for performing an outbound alert delivery 400. The alert information storage server 402 contains alert information 404. Alert information 404 can include user information, time and date of alert requests, personalized messages, system information, etc. In one implementation, the alert information storage server 402 periodically monitors the alert information 404 in order to find alert information 404 that matches a chosen date and time (such as the current date and time). In another implementation, the alert information storage server 402 performs the monitoring operation at non-periodic intervals. In yet another implementation, the alert information storage server 402 performs the monitoring operation at pre-determined intervals.. The monitoring operation can also encompass continuous monitoring instead of monitoring at intervals. Additionally, scanning the alert information storage server 402 in order to find alert information 404 that matches specific directories, files, attributes, etc. at certain times also can be considered a monitoring operation. Another possible implementation of the monitoring operation involves indexing or otherwise writing metadata concerning the alert information 404 stored on the alert information storage server 402 and accessing any alert information 404 that matches triggering date(s) and time(s).

When the alert information storage server 402 finds matching alert information 404, it sends the ripe alert information 404 to the alert messaging server 406. In another implementation, the alert information storage server 402 sends alert information 404 that reference the current day and time plus a set interval of date(s) and time(s). For example, at noon on the present date, the alert information storage server 402 sends all alert information 404 that is for alerts for the present date starting at noon plus fifteen minutes. In effect, all alert information 404 that is labeled for delivery between 12:00 pm and 12:15 pm on the present date is sent to the alert messaging server 406. In yet another implementation, different dates and/or times are used for matching purposes or the dates and/or times are replaced with some other triggering parameter or method of triggering ripe alerts.

In one implementation, the alert information that is sent to the alert messaging server 206 by the alert information storage server 402 includes both an alert log and an alert message. In another implementation, only an alert log is included in the alert information initially sent to the alert messaging server 206. Any associated alert message is retrieved from the alert information storage server in a separate transaction.

The alert messaging server 406 aggregates all incoming alert information 404, analyzes the information and schedules outgoing communications and delivery of alert messages. In one implementation, when the time is reached for a particular alert, the alert messaging server 406 notifies the outbound voice server 408. In another implementation, the alert messaging server 406 places all alert information 404 received from the alert information storage server 402 into one or more queues and delivers the first entry in the queues to the outbound voice server 408 either periodically, randomly, in a continuous stream, or at predetermined intervals.

In another implementation, the alert messaging server 406 aggregates the incoming alert information 404, creates a schedule, and manages an outbound alert information queue. When a particular alert needs to be acted upon, the alert messaging server 406 communicates the alert information 404 to the outbound voice server 408.

The outbound voice server 408 receives the alert information 404 from the alert messaging server 406. In one implementation, the outbound voice server 408 sends a VoiceXML or other set of instructions request to the alert application server 410 instructing it to build a VoiceXML page or other set of instructions from the alert information 404. The alert application server 410 sends the constructed VoiceXML page or other set of instructions to the outbound voice server 408.

In another implementation, the outbound voice server 408 analyzes the alert information 404 and constructs an appropriate VoiceXML page or other set of instructions itself. In yet another implementation, the alert messaging server 406 constructs a VoiceXML page or other set of instructions and sends it to the outbound voice server 408.

In one implementation, if the VoiceXML or other set of instructions specifies that an outgoing personalized alert message be delivered, the outbound voice server 408 sends an alert message request to the alert information storage server 402 requesting the appropriate personalized alert message. The alert information storage server 402 sends the personalized alert message to the outbound voice server 408. The outbound voice server 408 initiates an outbound communication over a communications network 412 to one or more receiving communications devices 414 as instructed in the VoiceXML page or other set of instructions and delivers the personalized alert message. In another implementation, the alert information 404 received by the outbound voice server 408 already includes any alert message so no additional communication with the alert information storage server 402 is necessary in order for the outbound voice server 408 to initiate an outbound communication over a communications network 412 to one or more receiving communications devices 414.

The receiving communications devices 414 are one or more communications devices. The receiving communications devices 414 can be any type of communications devices including, but not limited to, mobile phones, office phones, pay phones, computers using voice-over-internet-protocol (VOIP), home phones, email devices, etc. In an alternate implementation, the receiving communications devices 414 are one or more groups of communications devices. In one implementation, the outbound voice server 408 calls an alert recipient's home phone and delivers a voice message alert. In another implementation, the outbound voice server 408 creates an email, attaches an audio file containing a voice message alert, and sends the email to a recipient's email address. In yet another implementation, the outbound voice server 408 calls a recipient's mobile phone and delivers a video message alert. Other implementations in which the outbound voice server 408 delivers other types of communications and alerts are contemplated.

In one implementation, the alert information storage server 402 contains disaster recovery features. For example, when the alert information storage server 402 boots up, it launches an application that operates on a properties file. The properties file contains an entry for a first variable that is initially set to True. When the application shuts down for any reason, it sets the first variable to False and adds a second variable containing the date and time the last process ended. When next the application is launched, it compares the current date and time to the second variable date and time and re-delivers any missed alert messages.

It is important to realize that each of the servers described above can be implemented as an operation, as groups of operations or processes, as computer hardware, or as individual computer systems like those depicted in FIG. 4. In an alternate implementation, two or more of the servers can be implemented onto a single computer system, for example, as software products running concurrently on the computer system. In yet another implementation, individual server functionalities can be spread out across multiple computer systems either by having different computer systems perform different functions of the overall server functionalities or by having each computer system perform the complete set of server functionalities while dividing the workload among the computer systems. These features make the system highly scalable and highly fault tolerant. Thus, the system can easily and quickly grow in size and capacity as needed. In one implementation, the system includes multiple computing systems for each server described in FIG. 4, thereby making the-system fault tolerant; one or more computers that make up the system can experience a fault or otherwise fail without causing the system to stop functioning.

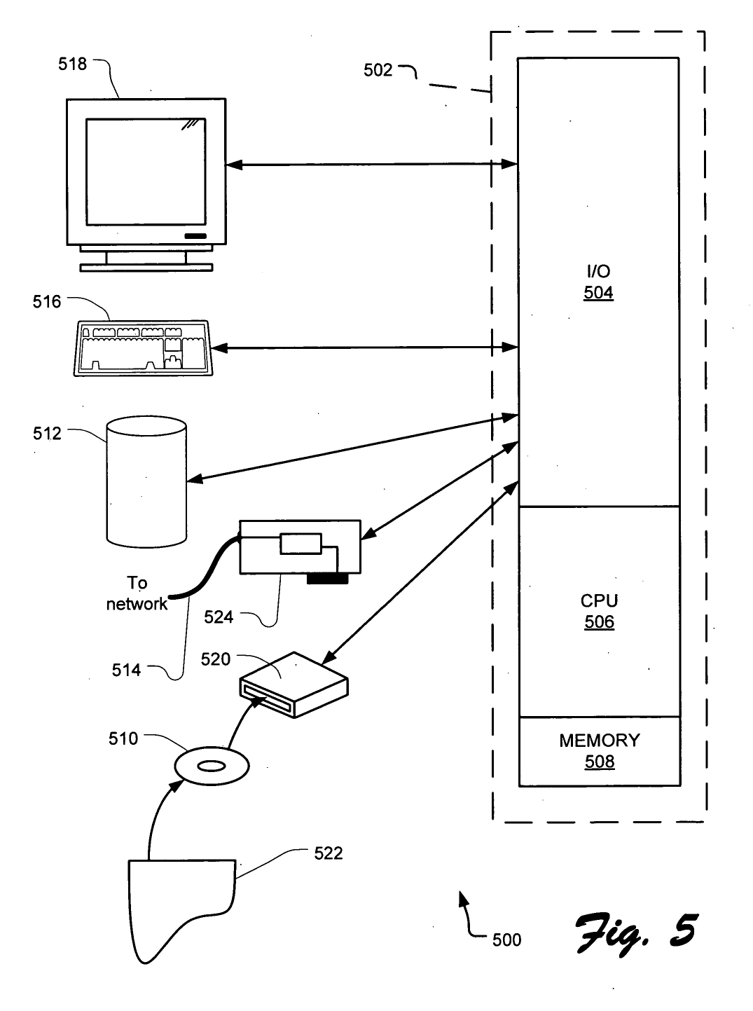

FIG. 5 illustrates an exemplary computing system useful in implementations of the described technology. A general purpose computer system 500 is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer. The described technology is optionally implemented in software devices loaded in memory 508, stored on a configured DVD/CD-ROM 510 or storage unit 512, and/or communicated via a wired or wireless network link 514 on a carrier signal, thereby transforming the computer system 500 in FIG. 5 into a special purpose machine for implementing the described operations.

The I/O section 504 is connected to one or more user-interface devices (e.g., a keyboard 516 and a display unit 518), a disk storage unit 512, and a disk drive unit 520. Generally, in contemporary systems, the disk drive unit 520 is a DVD/CD-ROM drive unit capable of reading the DVD/CD-ROM medium 510, which typically contains programs and data 522. Computer program products containing mechanisms to effectuate the systems and methods in accordance with the described technology may reside in the memory section 504, on a disk storage unit 512, or on the DVD/CD-ROM medium 510 of such a system 500. Alternatively, a disk drive unit 520 may be replaced or supplemented by a floppy drive unit, a tape drive unit, or other storage medium drive unit. The network adapter 524 is capable of connecting the computer system to a network via the network link 514, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are exemplary and other means of, and devices for, establishing a communications link between the computers may be used.

In accordance with an implementation, software instructions and data directed toward implementing a system and method for personalized automated alerts using interactive voice response and other operations may reside on disk storage unit 512, disk drive unit 520 or other storage medium units coupled to the system. Said software instructions may also be executed by CPU 506.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

1. A method of providing automated personalized alerts using interactive voice response, the method comprising:
receiving an initiating communication from a user;
interpreting the received initiating communication into digital data;
accessing account information for the user using the digital data;
communicating with the user to receive an alert having a triggering date and time and an associated action;
creating a storage entry containing the alert in a storage location;
monitoring the storage location in order to match the triggering date and time on the alert with a selected date and time;
sending the matched alert to an outgoing communications module;
interpreting the alert; and
performing the associated action.

2. The method of claim 1 wherein the operation of communicating with the user to receive an alert having a triggering date and time and an associated action further comprises:
constructing a set of personalized interaction instructions using the account information;
following the set of personalized interaction instructions;
employing interactive voice response to communicate with the user; and
receiving an alert having a triggering date and time and an associated action.

3. The method of claim 1 wherein the operation of creating a storage entry containing the alert further comprises:
creating a directory for the triggering date and time;
creating a file in the directory; and
storing the alert in the file.

4. A computer program product encoding a computer program for a computer process that executes on a computer system providing automated personalized alerts using interactive voice response, the computer process comprising:
receiving an initiating communication from a user;
interpreting the received initiating communication into digital data;
accessing account information for the user using the digital data;
communicating with the user to receive an alert having a triggering date and time and an associated action;
creating a storage entry containing the alert in a storage location;
monitoring the storage location in order to match the triggering date and time on the alert with a selected date and time;
sending the matched alert to an outgoing communications module;
interpreting the alert; and
performing the associated action.

5. The computer process of claim 4 wherein the operation of communicating with the user to receive an alert having a triggering date and time and an associated action further comprises:
constructing a set of personalized interaction instructions using the account information;
following the set of personalized interaction instructions;
employing interactive voice response to communicate with the user; and
receiving an alert having a triggering date and time and an associated action.

6. The computer process of claim 4 wherein the operation of creating a storage entry containing the alert further comprises:
creating a directory for the triggering date and time;
creating a file in the directory; and
storing the alert in the file.

7. A system for providing automated personalized alerts using interactive voice response comprising:
means for receiving an initiating communication from a user;
means for interpreting the received initiating communication into digital data;
means for accessing account information for the user using the digital data;
means for communicating with the user to receive an alert having a triggering date and time and an associated action;
means for creating a storage entry containing the alert in a storage location;
means for monitoring the storage location in order to match the triggering date and time on the alert with a selected date and time;
means for sending the matched alert to an outgoing communications module;
means for interpreting the alert; and
means for performing the associated action.

8. The system of claim 7 wherein the means for communicating with the user to receive an alert having a triggering date and time and an associated action includes at least constructing a set of personalized interaction instructions using the account information, following the set of personalized interaction instructions, employing interactive voice response to communicate with the user, and receiving an alert having a triggering date and time and an associated action.

9. The system of claim 7 wherein the means for creating a storage entry containing the alert includes at least creating a directory for the triggering date and time, creating a file in the directory, and storing the alert in the file.
